(19) United States
(12) Patent Application Publication
(10) Pub. No.: US 2024/0008470 A1
(43) Pub. Date: Jan. 11, 2024

(54) Adhesive Insect Trap

(71) Applicant: Carol Newman, Spring Valley, CA (US)

(72) Inventor: Carol Newman, Spring Valley, CA (US)

(21) Appl. No.: 17/942,701

(22) Filed: Sep. 12, 2022

Related U.S. Application Data
(60) Provisional application No. 63/358,918, filed on Jul. 7, 2022.

(51) Int. Cl. A01M 1/16

(52) U.S. Cl. CPC A01M 1/165

(57) ABSTRACT

The present invention relates generally to the field of insect traps. More specifically, the present invention relates to an adhesive insect trap and a dispenser for supply an insect tape. The device has a housing, with a button, a locking mechanism, and an interior space. The interior space has at least one spool for holding a supply of material and at least one spring. The spring makes the housing spring loaded in that the supply of material can be retracted with a press of the button. The supply of material has an adhesive coating on the top surface and at least one revealable adhesive spot or pattern on the bottom surface.

### CROSS-REFERENCE TO RELATED APPLICATION

The present application claims priority to, and the benefit of, U.S. Provisional Application No. 63/358,918, which was filed on Jul. 7, 2022, and is incorporated herein by reference in its entirety.

### FIELD OF THE INVENTION

The present invention relates generally to the field of pest strips and traps. More specifically, the present invention relates to an adhesive insect trapping device. The device is comprised primarily of a housing, having at least one button, at least one locking mechanism, and an interior space. The interior space includes at least one spool and at least one spring connected to the spool. The spring makes the housing spring loaded in that the strip can be retracted with a press of the button. The device also includes a strip or piece of material which may be extracted from the housing. The strip or material has an adhesive coating on one side in one embodiment on the top surface. The exposed adhesive catches the insects and prevents the insects from entering the home. The adhesive strip has at least one peelable adhesive member covered with a protective cover layer. In an alternate embodiment, the adhesive may be initially dormant and is then activatable when needed to avoid the use of the release strip. This allows a user to attach the strip to the desired surface. The device provides a novel and convenient way to prevent and eliminate insects that threaten to infest a home, work, restaurant, or other location. Accordingly, the present disclosure makes specific reference thereto. Nonetheless, it is to be appreciated that aspects of the present invention are also equally applicable to other like applications, devices, and methods of manufacture.

### BACKGROUND

Many individuals struggle with keeping pests such as insects out of their home, office, or other public gathering places such as restaurants and the like. Many pests and insects enter through openings or cracks around windows and doors and can quickly lead to large infestations within the home, office, or other areas. Once there are large amounts of insects or other pests within the home, office, or other areas, individuals often must turn to expensive exterminators or other pricey pest control means to eliminate the pests or insects. Cheaper insect control alternatives may not be particularly effective at stopping the pests or insects from entering the home. Many sprayable insect repellants may also be harmful to breathe, have contact with exposed skin, risk eye exposure, or leave behind unpleasant scents that may be an annoyance to the user and others that enter the home, office, or other location. Further, there are many insect repellants that are used once there are infestations within the home or office, but none to stop or prevent the insects or pests before they enter the home, office, or other area completely.

Therefore, there exists a long-felt need in the art for an improved insect trap that will prevent the ingress of insects or pests into a home, office, restaurant, or other area where people may congregate. Further, there exists a long-felt need in the art for an insect trap that catches the insects at the entry point such as the door or window before they can gain entry and potentially infest the home. There also exists a long-felt need in the art for an easy-to-use adhesive insect trapping material such as a strip that can be retracted into a housing after use for minimal clean-up and easy disposal. There also exists a long-felt need in the art for an insect trapping device that allows for convenient and easy application, clean-up and disposal.

The subject matter disclosed and claimed herein, in one embodiment thereof, comprises an adhesive insect trapping material. The device includes a housing or other container sized and configured to hold the material, and further includes at least one interior space, at least one button, at least one locking mechanism, and at least one lid. The interior space has at least one spool and at least one spring. The spool and spring allow for the spool, which holds a supply of material, to be automatically retracted when the user presses the button. This allows for easy disposal of the material when it is no longer needed.

The device also includes at least one strap, strip, or material portion. The supply of material has a bottom surface, a top surface, and at least one peelable adhesive member. The top surface of the supply of material has an adhesive coating that traps the insects to the material when the insects land or otherwise try and pass over the material. The peelable adhesive member further allows the user to attach a portion of the materials to the desired surface so the material does not move or twist, such as when exposed to a breeze or other windy conditions.

In this manner, the adhesive insect trapping device of the present invention accomplishes all of the foregoing objectives and provides a novel insect trapping device that eliminates the need for the use of costly exterminators or pest control. Further, the device prohibits insects from entering deep into a user's home, office, restaurant, or other locations where people usually congregate where the insects can cause infestations. The device also allows for convenient clean up and disposal when the user is done using the invention.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an adhesive insect trapping device. The device has a housing, with a top surface, bottom surface, a rear surface, side surfaces and an opening on the front surface to allow the material to be dispensed. The housing has an interior space that holds a supply of material. In differing embodiments, the housing may be any shape and may be provided with any graphics or indicia depicting the manufacturer's brand or other marketing information.

In one embodiment, the bottom surface may have at least one fastener in order to attach the housing to the desired surface. This prevents the housing from falling over and twisting the strip or removing the strip if the housing were to fall from a windowsill or other elevated area. The housing further includes at least one continuous opening located in the front surface. The continuous opening allows a user to pull the strip through the housing and out onto the desired area for installation of the material. The housing also is comprised of at least one lid located on the front surface. The lid can be maneuvered to close or open the continuous opening. The lid is opened and closed via at least one hinge. In one embodiment, the lid may have at least one fastener to fasten the lid in a shut or closed position.

The housing has an interior space sized and configured to hold a supply of material. The interior space has at least one spool for holding the supply of material. The spool may be any shape or orientation known in the art that allows for the user to easily extend and retract the material. The spool may have at least one spring. The spring creates a spring-loaded spool in that it retracts with minimal effort. The spring may be any spring or manufactured from any spring material known in the art.

The housing may have at least one button located on the top surface of the housing. In one embodiment, the button may be in the form of a pressable or depressible button that when pressed, the material inside the housing able to extend or retract. In this embodiment, when the user pushes the button one time, it allows for the user to pull the strip of material out to the desired in length for installation on a windowsill, floor, or other areas where bugs or insects may enter. When the user presses the button a second time, it locks the strip at the desired length. When the user presses the button a third time, it retracts the strip of material back into the housing.

In another embodiment, there may be multiple buttons, in which one button allows the strip or material to be pulled to the desired length. Another button locks the strip from further expanding or retracting, and another button automatically retracts the strip of material back into the housing. In another embodiment, the button may be in the form of a switch, such that at different orientations, the switch functions to extend, retract, or lock the strip. In varying embodiments, the housing may also have a locking mechanism separate from the button. The locking mechanism allows the user to lock the strip in place at the desired length. The locking mechanism is activated and operated via the button positioned on the top surface of the housing or by a simple lever that grips the strip of material and holds it against the base of the housing. The device further includes at least one strip provided from a supply of material. In the preferred embodiment, the top surface has an adhesive material which may be active or be activatable when needed. When insects crawl or land on the strip, they become stuck to the adhesive coating located on the top surface. This prevents the insects from entering the home, office, or other location and causing infestations or annoying the persons in the location. In the preferred embodiment, the bottom surface of the strip of material does not have an adhesive coating. This non-stick bottom surface allows the user to easily remove the device after use. The bottom surface may be provided with adhesive spots, spaced an equal distance apart and the adhesive spots may be covered with a release liner allowing the adhesive spots to hold the strip of material in position.

In one embodiment, the device is disposable. In the disposable embodiment, the device is single use in that once it is used, the strip and housing is thrown away. In another embodiment, the device is reusable. In the reusable embodiment, once the material is used, the strip is cut, and the user can pull more material to use the device again. The housing may have a tear bar at the opening of the housing or alternatively, the strip of material may be provided with regularly spaced perforation lines along the length of the tape or material.

The strip of material further includes a peelable adhesive member located on the bottom surface of the strip of material or tape. The peelable adhesive member allows a user to stick the end of the strip or tape to the desired surface so the strip of material does not move away from the door or window. In one disposable embodiment, the peelable adhesive member is located only at the end of the strip of material allowing the user to fasten the strip of material to the desired surface. In one reusable embodiment, the device may have peelable adhesive member located on the bottom surface at equal or set distances along the length of the strip such at one inch, three inch, six inch, and twelve inch intervals. In another reusable embodiment, the entire bottom surface of the strip may have a peelable release liner covering the adhesive. This would allow the user to cut the strip at any distance and still be able to peel a portion of the release liner on the bottom surface back to reveal the adhesive to stick the strip of material to the desired surface.

In another embodiment, a housing or dispenser for dispensing a supply of material is provided. The dispenser includes a housing, with a supply of material contained within the housing, and the supply of material having an upper surface and a lower surface with an adhesive provided on the upper surface and regularly spaced adhesive spots or patterns provided on the lower surface with the adhesive spots or patterns covered with a removable release liner, such as a silicone or wax paper liner. The supply of material may be provided with regularly occurring lines of weakness, tear lines or perforation lines along the length of the supply of material for tearing the supply of material from the dispenser.

Accordingly, the adhesive insect trapping device of the present invention is particularly advantageous as it provides users with a convenient way to lower the risk of insects entering their home, business, restaurants, or other gathering places. Further, it eliminates the need for expensive pest control alternatives. In this manner, the adhesive insect trapping device overcomes the limitations of existing insect trapping devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exploded side view of one potential embodiment of an adhesive insect trapping device of the present invention in accordance with the disclosed architecture;

FIG. 2 illustrates a perspective view of one potential embodiment of an adhesive insect trapping device of the present invention while in front of a door in accordance with the disclosed architecture;

FIG. 3 illustrates a perspective view of one potential embodiment of an adhesive insect trapping device of the present invention while in front of a window in accordance with the disclosed architecture;

FIG. 4 illustrates a perspective view of one potential embodiment of an adhesive insect trapping device of the present invention with the peelable adhesive member in accordance with the disclosed architecture;

FIG. 5 illustrates a flowchart of one potential method of using one potential disposable embodiment of the adhesive insect trapping device of the present invention in accordance with the disclosed architecture; and

FIG. 6 illustrates a flowchart of one potential method of using one potential reusable embodiment of the adhesive insect trapping device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved insect trap. Further, there exists a long-felt need in the art for an insect trap that catches the insects at the door or window before they can enter a home, office, restaurant, or other enclosure. There also exists a long-felt need in the art for an easy-to-use adhesive insect trapping device that can be retracted into a housing after use for minimal clean-up. There also exists a long-felt need in the art for an insect trapping device that allows for convenient and easy application and clean-up.

The subject matter disclosed and claimed herein, in one embodiment thereof, comprises an adhesive insect trapping device. The device includes a housing, with at least one interior space, at least one button, at least one locking mechanism, and at least one lid. Within the interior space is at least one spool and at least one spring. The spool and spring allow for the material to be automatically retracted when the user presses the button. This allows for easy disposal of the material as well as potentially the housing along with the used material enclosed within the housing. Further, the device has a supply of material which is sized and configured to fit within the confines of the housing and allow the material to be dispensed and retracted as needed. The material has a bottom surface, a top surface, and at least one peelable adhesive member. The top surface of the device has an adhesive coating that traps the insects to the strap when they land on it or try and pass over it. The peelable adhesive member further allows the user to attach a portion of the material to the desired surface so the material does not move or twist when applied to the desired location.

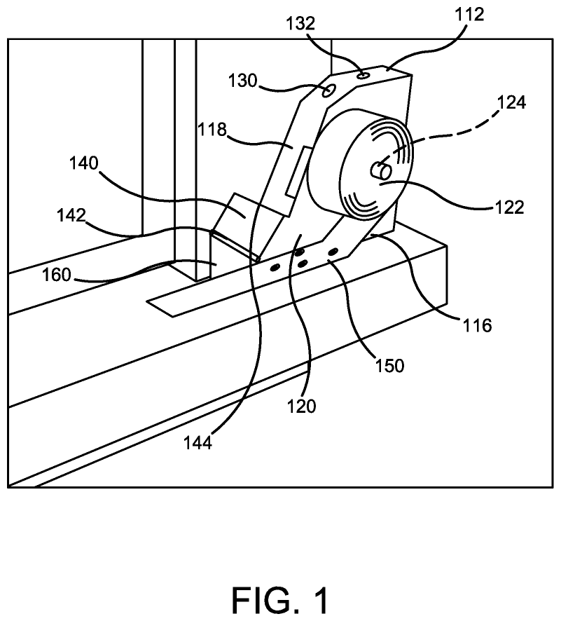

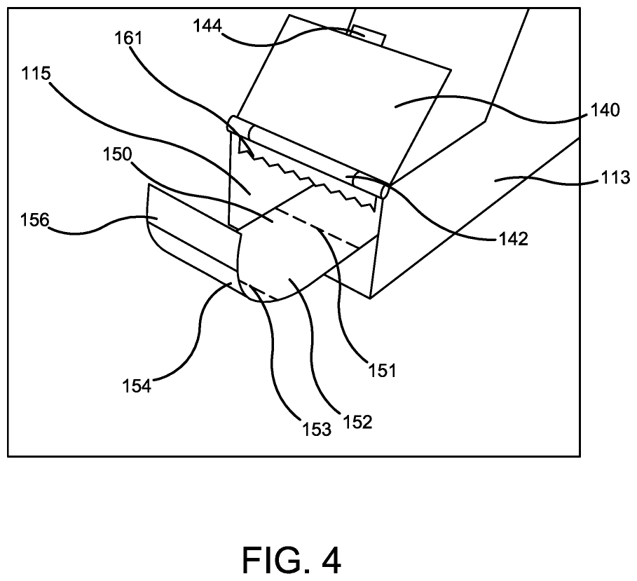

Referring initially to the drawings, FIG. 1 illustrates an exploded side view of one potential embodiment of an adhesive insect trapping device 100 of the present invention in accordance with the disclosed specification. The device 100 has a housing 110, with a top surface 112, bottom surface 116, and a rear surface 114 along with side surfaces 113, 115 (see FIG. 4). The housing 110 has an interior space 120 that holds the supply of material 150. In various embodiments, the housing 110 and all components may be made from a plurality of materials. One such material is a metal such as, but not limited to, brass, copper, aluminum, stainless steel, and combinations thereof. The preferred material is a rigid plastic such as, but not limited to: acrylic, polycarbonate, polyethylene, thermoplastic, acrylonitrile butadiene styrene, low-density polyethylene, medium density polyethylene, high-density polyethylene, polyethylene terephthalate, polyvinyl chloride, polystyrene, polylactic acid, acetal, nylon, fiberglass, recycled plastic, biodegradable plastic, and combinations thereof.

In differing embodiments, the housing 110 may be any shape such as, but not limited to: square, circle, polygonal, etc. In addition, the housing 110 may be shaped as any indicia such as, but not limited to: patterns, logos, emblems, images, symbols, designs, letters, numbers, words, characters, insects, advertisements, brands, etc., to give the housing 110 a themed appearance.

In one embodiment, the bottom surface 116 may have at least one fastener 119 in order to attach the housing 110 to the desired surface. This prevents the housing 110 from falling over and twisting the strip of material 150 once the material has been placed in position. The fasteners 119 that may be used are any fasteners known in the art such as, but not limited to: adhesive, magnetic, hook and loop, snap-button, suction cup, or combinations thereof. The housing 110 further includes at least one opening 160 located in the front surface 112. The opening 160 allows a user to pull the supply of material 150 through the housing 110 and out onto the desired area. The opening 160 may include a tear bar 161 so as to be able to tear off and remove the used strip or supply of material.

The housing 110 also has at least one lid 140 located on the front surface 118. The lid 140 can be maneuvered to access the opening 160. The lid 140 is opened and closed via at least one hinge 142. In various embodiments, the hinge 142 may be any hinge type known in the art such as, but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. The lid 140 is further closed via at least one fastener 144. The fastener 144 may be any fastener 144 such as, but not limited to: threaded, magnet, adhesive, hook and loop, snap-button, snap-cap, etc.

The housing 110 has an interior space 120 suitable in size to hold a supply of material For example, the supply of material may be a strip of material or tape that is provided in lengths of several feet such as 10, 15, 20 and 25 feet to allow a user to dispense material multiple times from the housing once a dispensed portion of material has been used.. The interior space 120 has at least one spool 122. The spool 122 may be any shape or orientation known in the art that allows for the user to easily extend and retract the supply of material 150. The spool 122 may have at least one spring 124. The spring 124 makes the spool 122 spring loaded, in that it retracts with minimal effort. The spring 124 may be any spring or manufactured from any spring material known in the art.

The housing 110 may have at least one button 130 located on the top surface 112 of the housing 110. In one embodiment, the button 110 may be in the form of a pressable or depressible button 130 that when pressed, the supply of material or strip 150 either is able to extend or retract. In this embodiment, when the user pushes the button 130 one time, it allows for the user to pull the supply of material or strip 150 out to the desired in length. When the user presses the button 130 a second time, it locks the strip 150 at the desired length. When the user presses the button 130 a third time, it retracts the strip 150 all the way into the housing 110.

In another embodiment, there may be multiple buttons 130, wherein one button 130 allows the strip 150 to be pulled to the desired length, another button 130 locks the strip 150, and another button 130 automatically retracts the strip 150 back into the housing 110. In another embodiment, the button 130 may be in the form of a switch, wherein at different orientations, the switch functions to extend, retract, or lock the strip 150.

In varying embodiments, the housing 110 may also have a locking mechanism 132. The locking mechanism 132 allows the user to lock the strip 150 in place at the desired length. The locking mechanism 132 is activated and operated via the button 130 positioned on the top surface 112 of the housing 110. The locking mechanism 132 can be any locking mechanism known in the art such as, but not limited to: a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a mechanical dial lock, a numerical combination lock, a pedestal lock, a draw lock, a fixed core lock, etc.

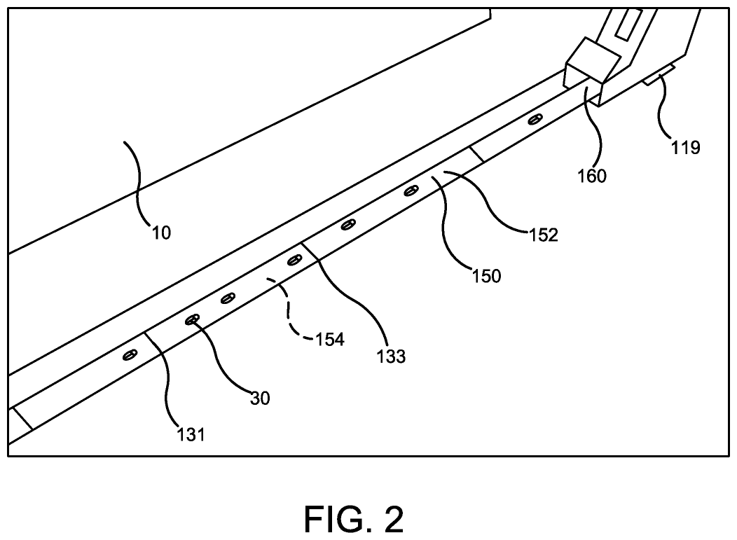

FIG. 2 illustrates a perspective view of one potential embodiment of an adhesive insect trapping device 100 of the present invention while in front of a door 10 in accordance with the disclosed specification. The device 100 has at least one material supply or strip 150. The strip 150 can be any strip material known in the art such as, but not limited to: plastic, paper, laminate, cardstock, or combinations thereof. The material forming the substrate for the supply of material or strip 150 may be made from virgin material or produced from post-consumer waste or renewable materials. In the preferred embodiment, the top surface 152 has an adhesive coating which may be active or activable. The active adhesive is preferably an acrylic adhesive. The activable adhesive may be activated by heat, moisture, or UV energy. Activatable adhesive is not tacky to the touch until activated. In this way, a user can position the supply of material at night and when; for example, people are not present, then activate the adhesive to capture pests that may only come out in the dark such as cockroaches or the like. When insects 30 crawl or land on the strip 150 to enter the home, they become stuck to the adhesive coating located on the top surface 152. This prevents the insects 30 from entering the home and causing infestations. In the preferred embodiment, the bottom surface 154 of the strip 150 is not provided with adhesive coating. This non-stick bottom surface 154 allows the user to easily remove the device 100 after use. The supply of material may be provided with one or more separation lines 131 and 133 which may be perforation lines or tear lines. If perforation lines are provided, perforations have a series of ties, and the tie size should be between 0.5 mm-2 mm and a cut size between 0.8 mm-12 mm. The adhesive material provided on the top surface may also include an insecticide.

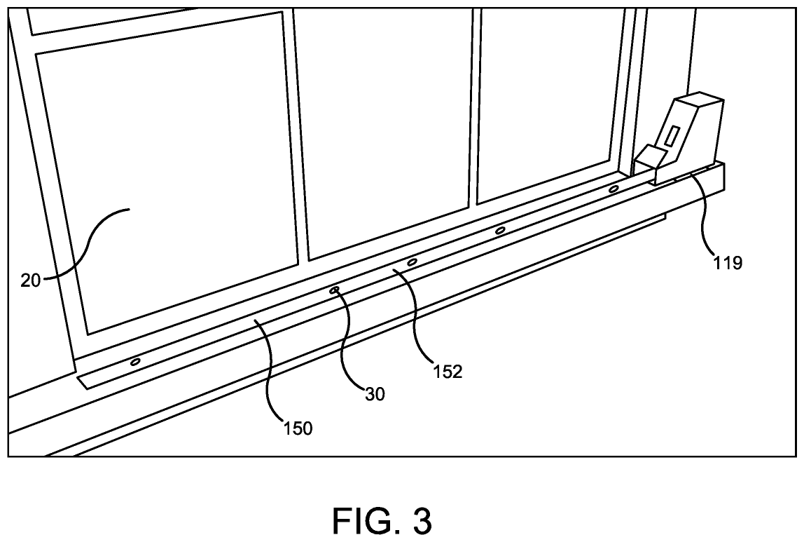

FIG. 3 illustrates a perspective view of one potential embodiment of an adhesive insect trapping device 100 of the present invention while applied on a windowsill 20 in accordance with the disclosed specification. In one embodiment, the device 100 is disposable. In the disposable embodiment, the device 100 is single use in that once it is used, the whole device 100 is thrown away. In another embodiment, the device 100 is reusable. In the reusable embodiment, once the device 100 is used, the strip 150 is cut, or torn along lines of separation and the user can pull more strip 150 to use the device 100 again.

FIG. 4 illustrates a perspective view of one potential embodiment of an adhesive insect trapping device 100 of the present invention with the peelable adhesive member 156 in accordance with the disclosed specification. The device 100 includes an adhesive member having a removable liner 156 located on the bottom surface 154 of the strip 150. The revealable adhesive member 156 allows a user to stick the end of the strip 150 to the desired surface so the strip 150 does not move away from the door 10 or window 20. In the disposable embodiment, the peelable adhesive member 156 is located only at the end of the strip 150 allowing the user to fasten the strip 150 to the desired surface. In one reusable embodiment, the device 100 may have an exposable adhesive member 156 located on the bottom surface 154 at set distances along the strip 150, such as at intervals of 3 inches or 6 inches. In another reusable embodiment, the entire bottom surface 154 of the strip 150 may have a revealable adhesive. This would allow the user to cut the strip 150 at any distance and still be able to peel a portion of the bottom surface 154 back to stick the strip 150 to the desired surface. The supply of material may have a number of regularly occurring perforation lines 151 and 153 disposed along the length of the tape or strip of material

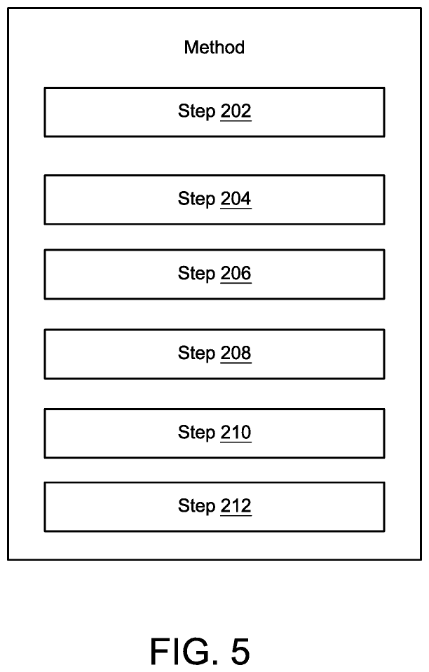

FIG. 5 illustrates a flowchart of one potential method 200 of using one potential disposable embodiment of the adhesive insect trapping device 100 of the present invention in accordance with the disclosed specification. First, the user pulls the strip 150 out to a desired length such as the width of the door 10 or windowsill 20 [Step 202]. Next, the user peels back the release liner to reveal adhesive 156 and sticks the adhesive 156 to the desired surface [Step 204]. Then, the user places the housing 110 on the desired surface via the fastener 119 located on the bottom surface 116 [Step 206]. Then, when the user is done using the device 100, they pull on the housing 100 upward such that the fastener 119 on the housing 110 detaches from the surface [Step 208]. Next, the user presses the button 130 located on the housing 110, which automatically retracts the supply of material or strip 150 into the interior space 120 [Step 210]. Finally, the user disposes of the used device 100 into the garbage [Step 212].

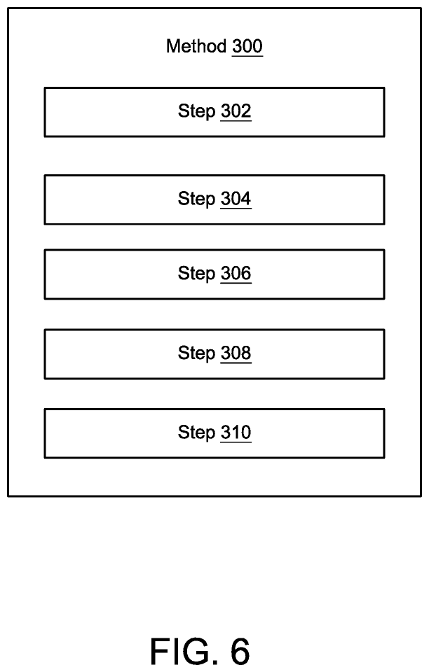

FIG. 6 illustrates a flowchart of one potential method 300 of using one potential reusable embodiment of the adhesive insect trapping device 100 of the present invention in accordance with the disclosed specification. First, the user pulls the supply of material or strip 150 out to the length of the door 10 [Step 302]. Next, the user peels back the liner to reveal the adhesive 156 and sticks the adhesive 156 to the desired surface [Step 304]. Then, the user places the housing 110 on the desired surface via the fastener 119 located on the bottom surface 116 [Step 306]. Then, when the user is done using the device 100, they cut or tear the strip 150 close to the housing 110 and pull the unused strip 150 the width of the door/window 10, 20, and then place the strip 150 again on the desired surface [Step 308]. The user then disposes of the portion of the used strip 150 [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “insect trapping device” and “device” are interchangeable and refer to the insect trapping device 100 of the present invention.

Notwithstanding the foregoing, the insect trapping device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the insect trapping device 100 as shown in the FIGS. are for illustrative purposes only, and that many other sizes and shapes of the insect trapping device 100 are well within the scope of the present disclosure. Although the dimensions of the insect trapping device 100 are important design parameters for user convenience, the insect trapping device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An insect trap comprising:
a supply of material comprised of a top surface having an adhesive coating, and a bottom surface;
a housing having an interior space sized and configured to house the supply of material, wherein the housing is comprised of a base, a top, a back portion, a front portion and a side wall;
an opening in the front portion for dispensing the supply of material; and
a spool for holding the supply of material.

2. An insect trap as recited in claim 1, wherein the adhesive comprises an insecticide.

3. An insect trap as recited in claim 1, wherein the bottom surface of the supply of material is comprised of a revealable adhesive covered by a release liner.

4. An insect trap as recited in claim 1, wherein the revealable adhesive is positioned in equally spaced distances long the supply of material.

5. An insect trap as recited in claim 1, wherein the adhesive is a coating of adhesive and is one of an active or activatable adhesive.

6. An insect trap as recited in claim 5, wherein the adhesive is activated by one of a heat, a moisture or a UV energy.

7. An insect trap as recited in claim 1, wherein the adhesive is an acrylic adhesive.

8. An insect trap as recited in claim 1, wherein the housing further comprises at least one button to release the supply of material.

9. An insect trap as recited in claim 1, wherein the housing further comprises a spring to retract the supply of material.

10. An insect trap as recited in claim 1, wherein the supply of material further comprises a plurality of regularly spaced perforation lines.

11. An insect trap as recited in claim 10, wherein the plurality of regularly spaced perforation lines is comprised of a plurality of cuts and a plurality of ties.

12. An insect trap as recited in claim 11, wherein each of the plurality of ties is between 0.5 mm and 2 mm, and each of the plurality of cuts is between 0.8 mm and 12 mm.

13. An adhesive pest trap comprising:
a supply of material comprised of a front surface and a bottom surface, wherein the front surface is comprised of a coating of adhesive and the bottom surface is comprised of a revealable adhesive;
a housing sized and configured to hold the supply of material, wherein the supply of material is positioned within the housing and comprises a top, a bottom, a pair of sides, a rear and a front, and further wherein an opening is positioned on the front to dispense the supply of material; and
a button positioned on the housing to release or retract the supply of material.

14. An adhesive pest trap as recited in claim 13, wherein the housing further comprises a spool for supporting the supply of material.

15. An adhesive pest trap as recited in claim 14, wherein the housing further comprises a spring connected to the spool to retract the supply of material upon depressing the button.

16. An adhesive pest trap as recited in claim 13 further comprising a fastener to hold the housing to a surface.

17. An adhesive pest trap as recited in claim 13, wherein the supply of material comprises a plurality of tear or perforation lines.

18. An adhesive pest trap as recited in claim 13, wherein the adhesive is one of an active adhesive or an activatable adhesive.

19. An adhesive pest trap as recited in claim 13, wherein the revealable adhesive is positioned along the supply of material in regular increments of either three inches or six inches.

20. A dispenser for an insect trapping strip, the dispenser comprising:
a supply of material comprised of an upper surface and a lower surface, wherein a coating of adhesive is positioned along the upper surface and the lower surface comprises a regularly spaced pattern or spots of a revealable adhesive covered by a release liner;
a housing sized and configured to hold the supply of material;
a spool for holding the supply of material; and
a spring connected to the supply of material to retract the supply of material, wherein the supply of material further comprises a plurality of regularly spaced lines of weakness, tear lines or perforation lines.
